(19) United States
(12) Patent Application Publication
(10) Pub. No.: US 2025/0068039 A1
(43) Pub. Date: Feb. 27, 2025

(54) IMAGING APPARATUS

(71) Applicant: CANON KABUSHIKI KAISHA, Tokyo (JP)

(72) Inventor: SHOTA TANAKA, Chiba (JP)

(21) Appl. No.: 18/807,710

(22) Filed: Aug. 16, 2024

(30) Foreign Application Priority Data
Aug. 21, 2023 (JP) 2023-133859

(51) Int. Cl. G03B 17/14

(52) U.S. Cl. CPC G03B 17/14

(57) ABSTRACT

An imaging apparatus includes a lens holder having an opening and configured to hold a lens, and a filter holder configured to hold a filter such that the filter is insertable to and removable from an optical path of the lens, wherein at least one of the filter or the filter holder is at least partially arranged in the opening so as to overlap at least a portion of the lens holder as viewed in a direction perpendicular to an optical axis direction of the lens.

### BACKGROUND

### Field

The present disclosure relates to an imaging apparatus equipped with a filter insertion/removal mechanism.

### Description of the Related Art

Conventionally, there are widely known imaging apparatuses that are equipped with a filter insertion/removal mechanism allowing insertion and removal of a filter, such as an infrared (IR) cut filter, so that imaging can be performed even in a low-illumination environment. The filter insertion/removal mechanism is arranged in front of an imaging element. Therefore, a backfocus is normally extended in proportion to the thickness of the filter insertion/removal mechanism in an optical axis direction, which leads to an increase in the size of the imaging apparatus.

As a technique for a filter insertion/removal mechanism, Japanese Patent Application Laid-Open No. 2016-33594 discusses a technique for shortening a backfocus by arranging a filter movement frame that holds a filter outside an optical path and reducing the thickness of a member arranged in the optical path.

However, the technique discussed in Japanese Patent Application Laid-Open No. 2016-33594 does not take into consideration the positional relationship between a lens holding frame that holds a lens and a filter holding frame that holds a filter, and thus, there is a possibility that the backfocus may become long.

### SUMMARY

The present disclosure is directed to providing an imaging apparatus equipped with a filter insertion/removal mechanism that can shorten a backfocus.

According to some embodiments, an imaging apparatus can include a lens holder having an opening and configured to hold a lens, and a filter holder configured to hold a filter such that the filter is insertable to and removable from an optical path of the lens, wherein at least one of the filter or the filter holder is at least partially arranged in the opening so as to overlap at least a portion of the lens holder as viewed in a direction perpendicular to an optical axis direction of the lens.

Further features of the present disclosure will become apparent from the following description of exemplary embodiments with reference to the attached drawings.

### BRIEF DESCRIPTION OF THE DRAWINGS

FIG. 1 is a perspective view of an imaging apparatus (lens barrel) according to a first exemplary embodiment.

FIG. 2 is an exploded perspective view of the imaging apparatus according to the first exemplary embodiment.

FIG. 3 is a perspective view of a filter frame according to the first exemplary embodiment.

FIG. 4 is a front view of a fourth lens holder according to the first exemplary embodiment.

FIG. 5 is a rear view of a filter unit and its surroundings according to the first exemplary embodiment when a filter is arranged in an optical path.

FIG. 6 is a rear view of the filter unit and its surroundings according to the first exemplary embodiment when the filter is arranged outside the optical path.

FIG. 7 is a cross-sectional view illustrating the filter unit and its surroundings according to the first exemplary embodiment.

FIG. 8 is a cross-sectional view illustrating a filter unit and its surroundings according to a second exemplary embodiment.

FIG. 9 is a perspective view of a fourth lens holder according to a third exemplary embodiment.

FIG. 10 is a rear view of a filter unit and its surroundings according to the third exemplary embodiment when a filter is arranged in an optical path.

FIG. 11 is a rear view of the filter unit and its surroundings according to the third exemplary embodiment when the filter is arranged outside the optical path.

FIG. 12 is a cross-sectional view illustrating the filter unit and its surroundings according to the third exemplary embodiment.

FIG. 13 is a perspective view of a lens barrel according to a fourth exemplary embodiment.

FIG. 14 is an exploded perspective view of the lens barrel according to the fourth exemplary embodiment.

FIG. 15 is a front view of a fourth lens holder according to the fourth exemplary embodiment.

FIG. 16 is a cross-sectional view illustrating a filter unit and its surroundings according to the fourth exemplary embodiment.

FIG. 17 is a perspective view of a filter frame according to a fifth exemplary embodiment.

FIG. 18 is a perspective view of a second filter holder according to the fifth exemplary embodiment.

FIG. 19 is a cross-sectional view of a filter unit and its surroundings according to the fifth exemplary embodiment.

### DESCRIPTION OF THE EMBODIMENTS

Various exemplary embodiments, features, and aspects of the present disclosure will be described in detail with reference to the attached drawings.

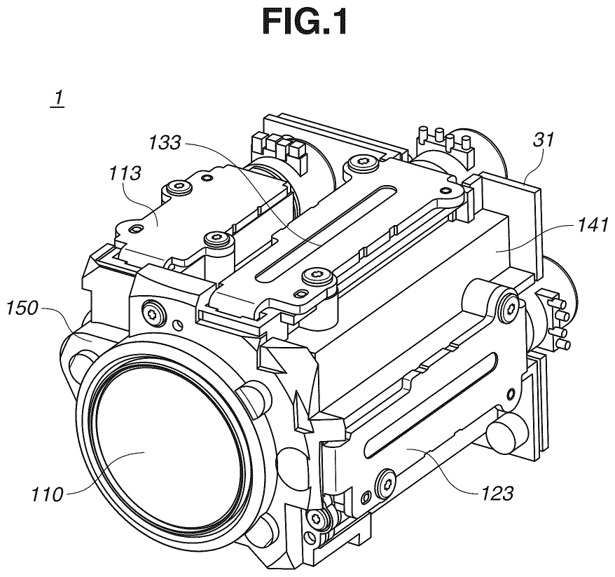

Hereinafter, an imaging apparatus according to a first exemplary embodiment of the present disclosure will be described with reference to FIGS. 1 to 7.

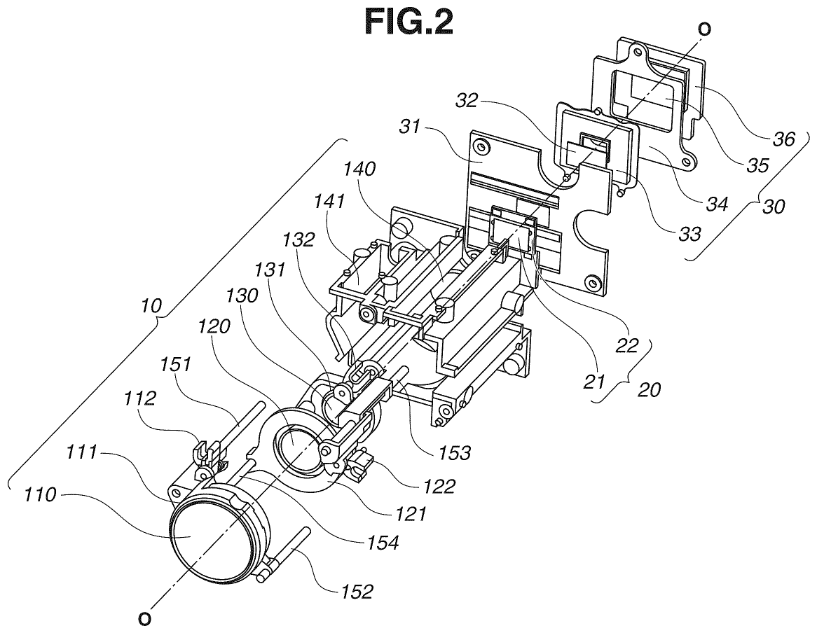

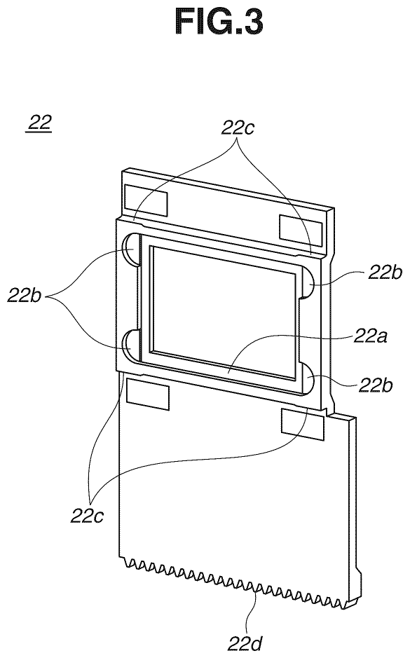

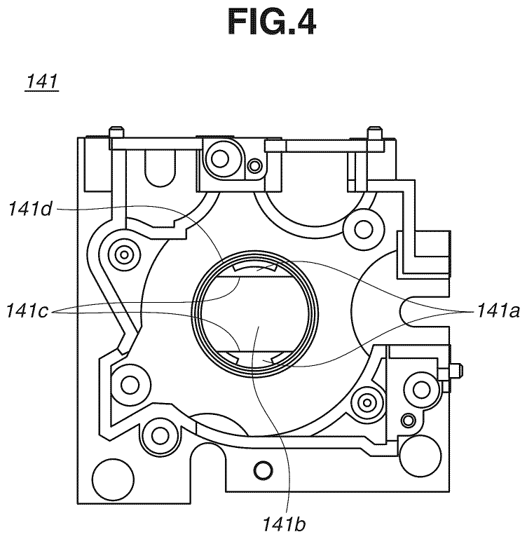

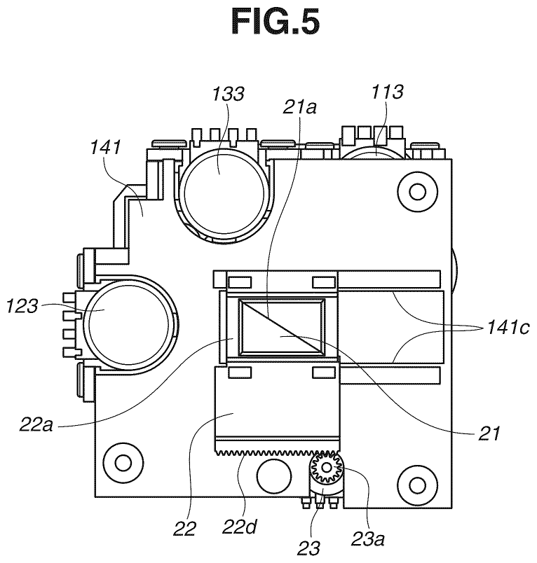

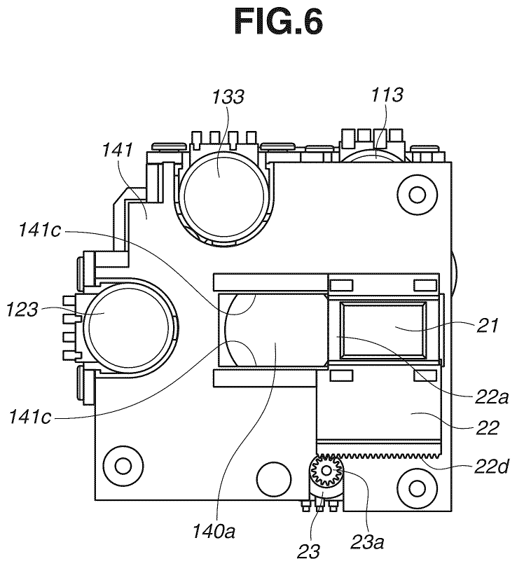

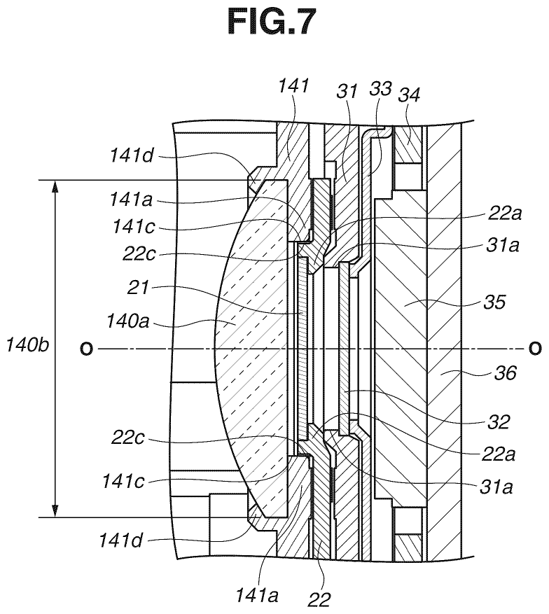

FIG. 1 is a perspective view of the imaging apparatus according to the first exemplary embodiment. FIG. 2 is an exploded perspective view of the imaging apparatus according to the first exemplary embodiment. FIG. 3 is a perspective view of a filter frame according to the first exemplary embodiment. The imaging apparatus includes a lens barrel 1 and an imaging unit 30. The lens barrel 1 includes a lens unit 10 and a filter unit 20. FIG. 4 is a front view (seen from a subject side) of a fourth lens holder according to the first exemplary embodiment. FIG. 5 is a rear view of the filter unit 20 and its surroundings when the filter is arranged in an optical path according to the first exemplary embodiment. FIG. 6 is a rear view of the filter unit 20 and its surroundings when the filter is arranged outside the optical path according to the first exemplary embodiment. FIG. 7 is a cross-sectional view of the filter unit 20 and its surroundings according to the first exemplary embodiment.

The lens unit 10 includes an imaging optical system including, in order from the subject side, a first lens unit 110, a second lens unit 120, a third lens unit 130, and a fourth lens unit 140. The lens unit 10 further includes a front sleeve 150 and a rear sleeve (fourth lens holder 141), and the front sleeve 150 and the rear sleeve constitute a housing.

The first lens unit 110 is held by a first lens holder 111. The first lens holder 111 is engaged with and supported by a guide bar 151 so as to be movable in an optical axis direction of the imaging optical system (the optical axis is denoted by “O” in the drawings). The first lens holder 111 is also engaged with a guide bar 152 and is restricted from rotating around the guide bar 151.

The first lens holder 111 holds a first unit rack 112. The first unit rack 112 is engaged with a lead screw portion of a first unit drive unit 113 that includes an actuator, such as a stepping motor. When the lead screw portion is rotated by the first unit drive unit 113, the first lens holder 111 moves together with the first unit rack 112 in the optical axis direction of the imaging optical system.

The second lens unit 120 is held by a second lens holder 121. The second lens holder 121 is engaged with and supported by a guide bar 153 so as to be movable in the optical axis direction of the imaging optical system. The second lens holder 121 is also engaged with a guide bar 154 and is restricted from rotating around the guide bar 153.

The second lens holder 121 also holds a second unit rack 122. The second unit rack 122 is engaged with a lead screw portion of a second unit drive unit 123 that includes an actuator such as a stepping motor. When the lead screw portion is rotated by the second unit drive unit 123, the second lens holder 121 moves together with the second unit rack 122 in the optical axis direction of the imaging optical system.

The third lens unit 130 is held by a third lens holder 131. The third lens holder 131 is engaged with and supported by the guide bar 153 so as to be movable in the optical axis direction of the imaging optical system. The third lens holder 131 is also engaged with the guide bar 154 and is restricted from rotating around the guide bar 153.

The third lens holder 131 also holds a third unit rack 132. The third unit rack 132 is engaged with a lead screw portion of a third unit drive unit 133 including an actuator, such as a stepping motor. When the lead screw portion is rotated by the third unit drive unit 133, the third lens holder 131 moves together with the third unit rack 132 in the optical axis direction of the imaging optical system.

The fourth lens unit 140 is held by a fourth lens holder 141. The fourth lens holder 141 will be described below in detail.

The guide bars 151, 152, 153, and 154 are held by the front sleeve 150 and the fourth lens holder 141. The first unit drive unit 113, the second unit drive unit 123, and the third unit drive unit 133 are fixed to the fourth lens holder 141.

Zooming and focusing of the imaging optical system are performed by moving the first lens unit 110, the second lens unit 120, and the third lens unit 130 in a predetermined positional relationship in the optical axis direction of the imaging optical system. The lens configuration of the lens unit 10 is not limited to the above-described example.

The filter unit 20 includes a filter (or optical filter) 21, a filter frame 22, and a filter drive unit 23 (FIG. 5). The filter 21 is an optical filter, such as an infrared (IR) cut filter. A diagonal length 21a of the filter 21 is smaller than a diameter 140b of a lens 140a of the fourth lens unit 140 that is configured to be closest to the filter 21 in the optical axis direction. This configuration reduces the area where the filter 21 and a filter holding part (or optical filter holding part) 22a (described below) pass when they are inserted into or removed from the optical path as viewed in the optical axis direction, making it easier to secure a space for a lens holding part 141a (described below) of the fourth lens holder 141.

The filter frame 22 holds the filter 21. The filter frame 22 includes the filter holding part 22a, and the filter 21 is in contact with the filter holding part 22a. The filter frame 22 includes groove parts 22b, and the filter 21 is fixed to the filter frame 22 by applying an adhesive to the groove parts 22b and allowing the adhesive to harden. The filter frame 22 may hold a plurality of filters. The filter frame 22 includes filter frame side surfaces 22c on its sides, and the filter frame side surfaces 22c engage with lens holding part side surfaces 141c (described below) of the fourth lens holder 141.

The filter frame 22 also includes a gear part 22d at its end. The gear part 22d engages with a gear part 23a of the filter drive unit 23. The filter drive unit 23 includes an actuator, such as a stepping motor, to rotate the gear part 23a. When the gear part 23a is rotated by the filter drive unit 23, the filter frame 22 moves in a direction perpendicular to the optical axis. Moving the filter frame 22 in this manner allows the filter 21 to be inserted into or removed from the optical path. The driving method for inserting or removing the filter is not limited to the above-described example. The filter frame 22 is interposed between the fourth lens holder 141 and the sensor holder 31 in the optical axis direction. This configuration restricts the movement of the filter frame 22 in the optical axis direction. The method for restricting the movement of the filter frame 22 in the optical axis direction is not limited to the above-described example.

The imaging unit 30 collects light and forms an image on an imaging element 35 using the collected light, thereby obtaining a desired image. The imaging unit 30 includes a sensor holder 31, a second filter 32, a sensor rubber 33, a sensor plate 34, the imaging element 35, and an imaging board 36. The second filter 32 is a filter such as a low-pass filter. The sensor holder 31 includes a second filter holding part 31a (FIG. 7), and the second filter 32 is in contact with the second filter holding part 31a. The second filter 32 is pressed against and held on the second filter holding part 31a by the sensor rubber 33.

The imaging element 35 is mounted on the imaging board 36. The imaging element 35 is fixed to an opening of the sensor plate 34 using an adhesive. The sensor plate 34 is fixed to the sensor holder 31 with screws or the like. The imaging unit 30 does not necessarily need to include the second filter 32 and the sensor rubber 33.

The imaging unit 30 does not necessarily need to include the sensor plate 34, and the imaging board 36 may be fixed to the sensor holder 31. In addition, the imaging unit 30 does not necessarily need to include the sensor holder 31, and the imaging board 36 or the sensor plate 34 may be fixed to the fourth lens holder 141.

Next, a configuration of the fourth lens holder 141 and a configuration of the filter unit 20 and its surroundings will be described in detail.

The fourth lens holder 141 holds the fourth lens unit 140. The fourth lens holder 141 includes the lens holding part 141a, an opening 141b, the lens holding part side surfaces 141c, and a lens holding part 141d. The lens holding part 141a is in contact with the lens 140a of the fourth lens unit 140, which is configured to be closest to the filter 21 in the optical axis direction. The lens holding part 141a is partially formed at a position that does not overlap with the area where the filter 21 and the filter holding part 22a pass when they are inserted or removed as viewed in the optical axis direction.

A portion of the filter holding part 22a is arranged in the opening 141b. Thus, as viewed in the direction perpendicular to the optical axis, the lens holding part 141a of the fourth lens holder 141 and the filter 21 at least partially overlap each other.

In other words, at least a portion of the filter holding part 22a is arranged in the opening 141b so as to overlap at least a portion of the fourth lens holder 141, as viewed in the direction perpendicular to the optical axis direction of the fourth lens unit 140.

Accordingly, the lens 140a of the fourth lens holder 141 and the filter 21 can be closer to each other. This reduces the space in the optical axis direction for insertion and removal of the filter 21, thereby making it possible to shorten the back focus and make the imaging apparatus thinner.

The lens holding part side surfaces 141c extend in the direction perpendicular to the optical axis. The lens holding part side surfaces 141c are in contact with the filter frame side surfaces 22c of the filter frame 22. The lens holding part side surfaces 141c restrict the movement of the filter frame 22 in the direction perpendicular to the optical axis.

The lens holding part 141d holds and fixes the fourth lens unit 140 between itself and the lens holding part 141a by thermal caulking.

In the present exemplary embodiment, the lens holding part 141a is formed partially in the fourth lens holder 141. Alternatively, the lens holding part 141a may be formed around the entire circumference of the lens 140a. In this case, the lens holding part 141a needs to be partially concaved in the area where the optical filter 21 and the optical filter holding part 22a pass when they are inserted or removed, so as not to interfere with the optical filter 21 and the optical filter holding part 22a.

As illustrated in FIG. 7, at least a portion of the filter frame 22 overlaps the second filter holding part 31a as viewed in the direction perpendicular to the optical axis. This configuration allows the filter 21 and the second filter 32 to be closer to each other. As a result, this reduces the space in the optical axis direction for insertion and removal of the filter 21, thereby making it possible to shorten the back focus and make the imaging apparatus thinner.

Next, insertion and removal of the filter 21 into and from the optical path will be described. When the gear part 23a is rotated by the filter drive unit 23 in the state illustrated in FIG. 5, the filter frame 22 moves in the direction perpendicular to the optical axis.

At this time, the filter frame side surfaces 22c of the filter frame 22 moves along the lens holding part side surfaces 141c of the fourth lens holder 141 while being engaged with the lens holding part side surfaces 141c. This results in a state in which the filter is arranged outside the optical path (FIG. 6). On the other hand, when the gear part 23a is rotated by the filter drive unit 23 in the state illustrated in FIG. 6, the filter frame 22 moves in the direction perpendicular to the optical axis. At this time, the filter frame side surfaces 22c of the filter frame 22 move along the lens holding part side surfaces 141c of the fourth lens holder 141 while being engaged with the lens holding part side surfaces 141c. This results in a state in which the filter is arranged within the optical path (FIG. 5).

The filter 21 is configured to be inserted or removed in the long-side direction of the filter 21. With this configuration, the width of the area where the filter 21 and the filter holding part 22a pass when they are inserted or removed, as viewed in the optical axis direction, can be made smaller than that of the configuration in which the filter 21 is inserted or removed in the short-side direction of the filter 21.

Thus, it is easier to ensure a space for forming the lens holding part 141a.

With the above-described configuration, it is possible to provide an imaging apparatus equipped with a filter insertion/removal mechanism that can shorten a backfocus.

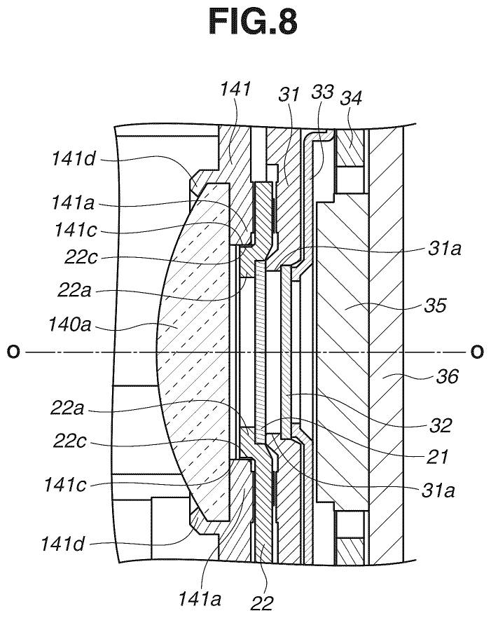

Hereinafter, an imaging apparatus according to a second exemplary embodiment of the present disclosure will be described with reference to FIG. 8. Components that are in common with the first exemplary embodiment are given the same reference signs and numerals as those in the first exemplary embodiment. Description of configurations that are in common with the first exemplary embodiment will be omitted. FIG. 8 is a cross-sectional view of a filter unit and its surroundings according to the second exemplary embodiment. In the second exemplary embodiment, the position of a filter 21 relative to a filter frame 22 is different from that in the first exemplary embodiment.

In the present exemplary embodiment, a filter unit 20 is arranged at a position where a lens holding part 141a and a filter holding part 22a at least partially overlap as viewed in the direction perpendicular to the optical axis.

Unlike in the first exemplary embodiment, the lens holding part 141a and the filter 21 do not overlap as viewed in the direction perpendicular to the optical axis.

With the above-described configuration, it is possible to provide an imaging apparatus equipped with a filter insertion/removal mechanism that can shorten a backfocus.

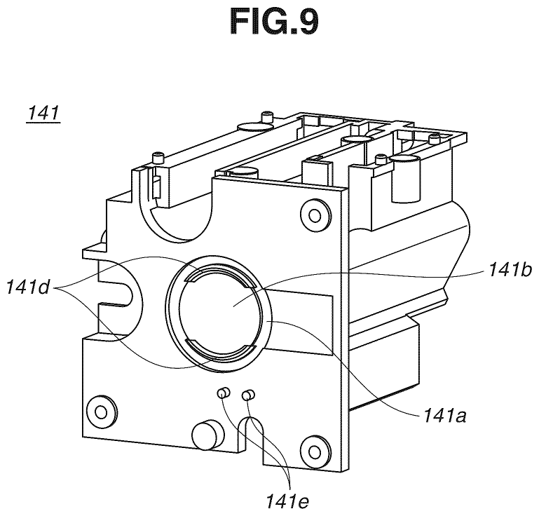

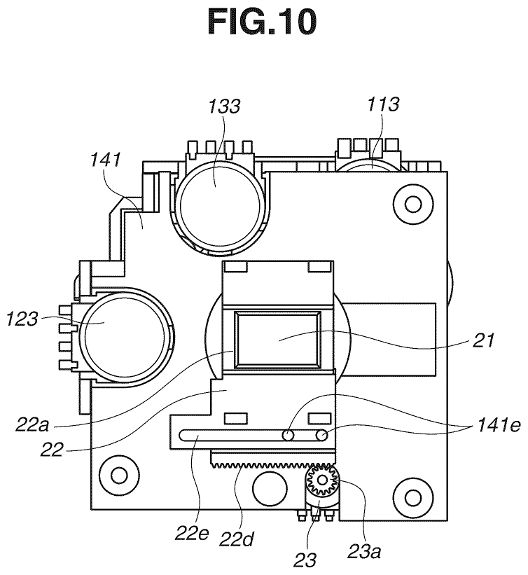

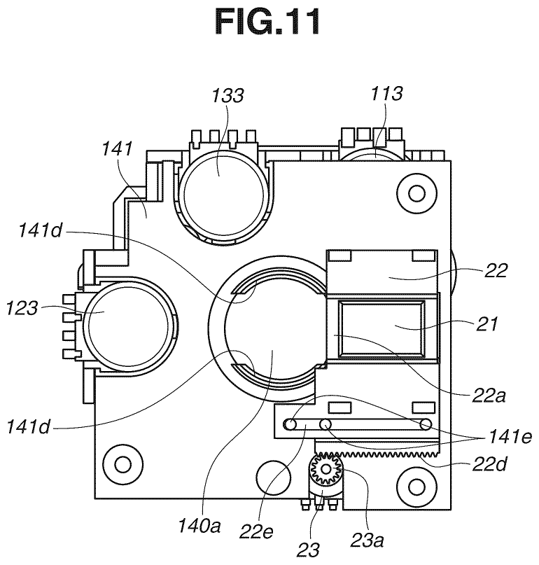

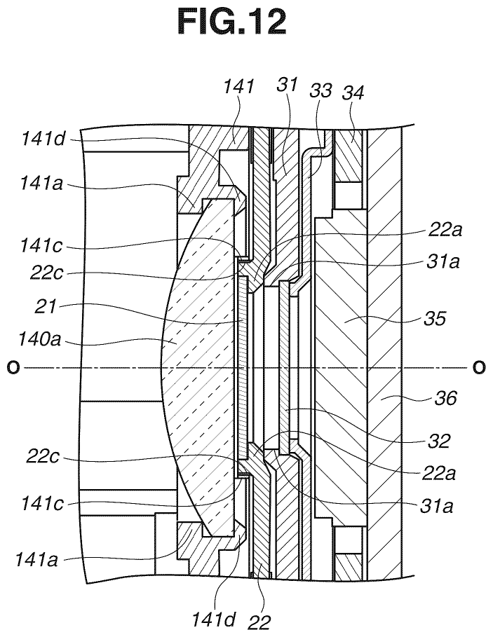

Hereinafter, an imaging apparatus according to a third exemplary embodiment of the present disclosure will be described with reference to FIGS. 9 to 12. Components that are in common with the first exemplary embodiment are given the same reference signs and numerals as those in the first exemplary embodiment. Description of configurations that are in common with the first exemplary embodiment will be omitted. FIG. 9 is a perspective view of a fourth lens holder according to the third exemplary embodiment. FIG. 10 is a rear view of a filter unit and its surroundings when a filter is in an optical path according to the third exemplary embodiment. FIG. 11 is a rear view of the filter unit and its surroundings when the filter is outside the optical path according to the third exemplary embodiment. FIG. 12 is a cross-sectional view of the filter unit and its surroundings according to the third exemplary embodiment.

In the first exemplary embodiment, the filter frame side surfaces 22c of the filter frame 22 move along the lens holding part side surfaces 141c of the fourth lens holder 141. In the present exemplary embodiment, a filter frame 22 moves in the direction perpendicular to the optical axis along guide pins 141e.

A lens 140a of a fourth lens unit 140, which is configured to be closest to the filter 21 in the optical axis direction, is in contact with a lens holding part 141a. The fourth lens unit 140 is interposed and fixed between a lens holding part 141d and the lens holding part 141a by thermal caulking. The lens holding part 141d of the fourth lens holder 141 is formed partially at a position that does not overlap with the area where the filter 21 and the filter holding part 22a pass when they are inserted or removed, as viewed in the optical axis direction. Although the lens holding part 141d is formed partially in the fourth lens holder 141 in the present exemplary embodiment, the lens holding part 141d may be formed around the entire circumference of the lens 140a. In this case, in the area through where the optical filter 21 and the optical filter holding part 22a pass when they are inserted or removed, the lens holding part 141d needs to be partially concaved so as not to interfere with the optical filter 21 and the optical filter holding part 22a.

Furthermore, the lens holding part 141d may be a separate member, such as a pressing ring fixed to the fourth lens holder 141.

The filter frame 22 has a guide hole 22e. The fourth lens holder 141 includes the guide pins 141e. The guide pins 141e are engaged with the guide hole 22e extending in the direction perpendicular to the optical axis, so that the filter frame 22 can move in the direction perpendicular to the optical axis along the guide pins 141e. When a gear part 23a is rotated by a filter drive unit 23, the filter frame 22 moves in the direction perpendicular to the optical axis while being guided by the guide pins 141e. By moving the filter frame 22 in this manner, the filter 21 can be inserted into or removed from the optical path. The method for moving the filter frame 22 in the direction perpendicular to the optical axis is not limited to the above-described configuration. In addition, the driving method for inserting or removing the filter is not limited to the above-described configuration.

In the present exemplary embodiment, the filter unit 20 is arranged at a position where the lens holding part 141d and the filter 21 at least partially overlap as viewed in the direction perpendicular to the optical axis. This allows the lens 140a and the filter 21 to be close to each other. Accordingly, it is possible to reduce the space in the optical axis direction for insertion and removal of the filter 21, thereby making it possible to shorten a backfocus and make the imaging apparatus thinner. As in the second exemplary embodiment, the filter holding part 22a and the filter holding part 141d may be configured to overlap each other in the optical axis direction.

With the above-described configuration, it is possible to provide an imaging apparatus equipped with a filter insertion/removal mechanism that can shorten a backfocus.

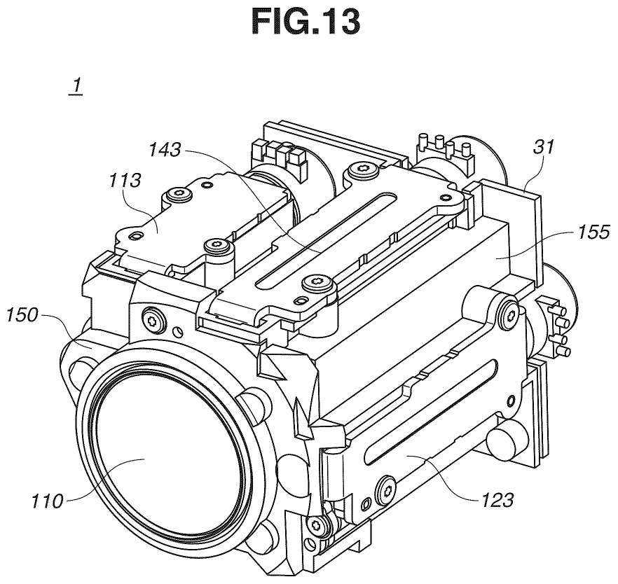

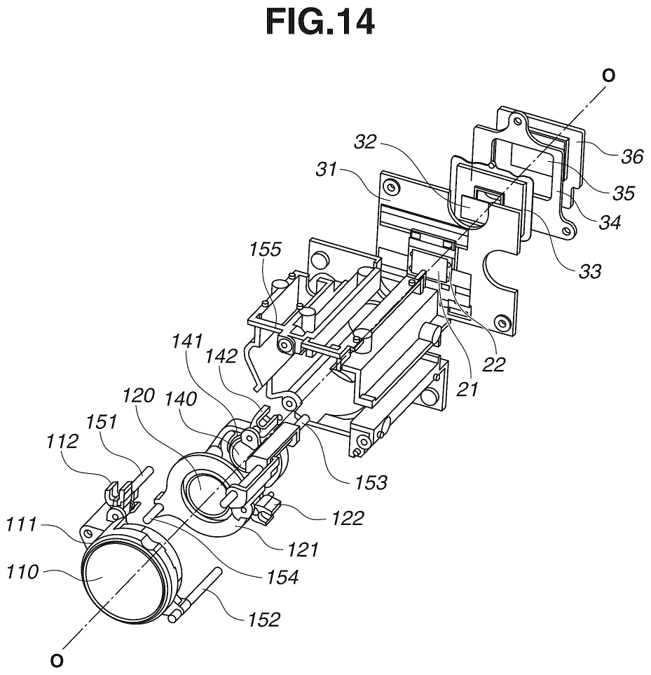

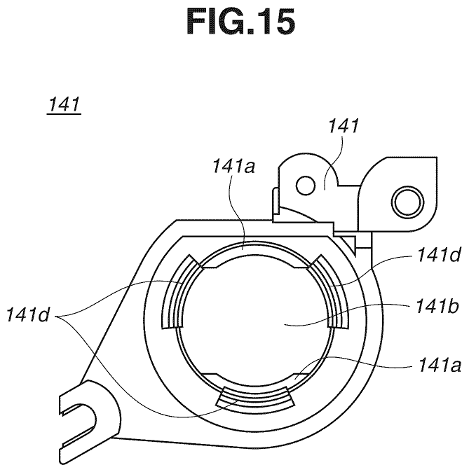

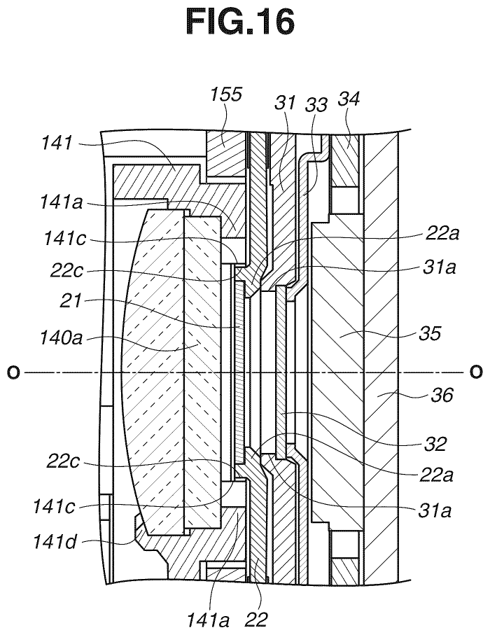

Hereinafter, an imaging apparatus according to a fourth exemplary embodiment of the present disclosure will be described with reference to FIGS. 13 to 16. Components that are in common with the first exemplary embodiment are given the same reference signs and numerals as those in the first exemplary embodiment. Description of configurations that are in common with the first exemplary embodiment will be omitted. FIG. 13 is a perspective view of a lens barrel according to the fourth exemplary embodiment. FIG. 14 is an exploded perspective view of the lens barrel according to the fourth exemplary embodiment. FIG. 15 is a front view of a fourth lens holder according to the fourth exemplary embodiment. FIG. 16 is a cross-sectional view of a filter unit and its surroundings according to the fourth exemplary embodiment. In the fourth exemplary embodiment, a third lens unit 130 is not provided. Further, in the fourth exemplary embodiment, a fourth lens unit 140 is movable in an optical axis direction.

A lens unit 10 has an imaging optical system including, in order from the subject side, a first lens unit 110, a second lens unit 120, and the fourth lens unit 140. The fourth lens unit 140 is held by a fourth lens holder 141. The fourth lens holder 141 is engaged with and supported by a guide bar 153 so as to be movable in the optical axis direction of the imaging optical system. The fourth lens holder 141 is also engaged with a guide bar 154 and restricted from rotating around the guide bar 153.

The fourth lens holder 141 holds a fourth unit rack 142. The fourth unit rack 142 is engaged with a lead screw portion of a fourth unit drive unit 143 including an actuator, such as a stepping motor. When the lead screw portion is rotated by the fourth unit drive unit 143, the fourth lens holder 141 moves together with the fourth unit rack 142 in the optical axis direction of the imaging optical system. The guide bars 151, 152, 153, and 154 are held by a front sleeve 150 and a rear sleeve 155.

Zooming and focusing of the imaging optical system are performed by moving the first lens unit 110, the second lens unit 120, and the fourth lens unit 140 in a predetermined positional relationship in the optical axis direction of the imaging optical system.

When the fourth lens unit 140 moves toward the imaging element in the optical axis direction, the fourth lens unit 140 and a filter 21 are brought close to each other.

A lens holding part 141a for a lens 140a is formed partially at a position that does not overlap with the area where the filter 21 and a filter holding part 22a pass when they are inserted or removed, as viewed in the optical axis direction. This allows a filter unit 20 to be arranged at a position where the lens holding part 141a and the filter 21 at least partially overlap as viewed in the direction perpendicular to the optical axis. Accordingly, it is possible to bring the lens 140a and the filter 21 to be closer to each other, thereby making it possible to shorten a back focus and make the imaging apparatus thinner.

As in the second exemplary embodiment, the filter holding part 22a and filter holding part 141d may overlap in the optical axis direction. In addition, as in the third exemplary embodiment, the filter 21 or the filter holding part 22a and the filter holding part 141d may at least partially overlap in the optical axis direction.

With the above-described configuration, it is possible to provide an imaging apparatus equipped with a filter insertion/removal mechanism that can shorten a backfocus.

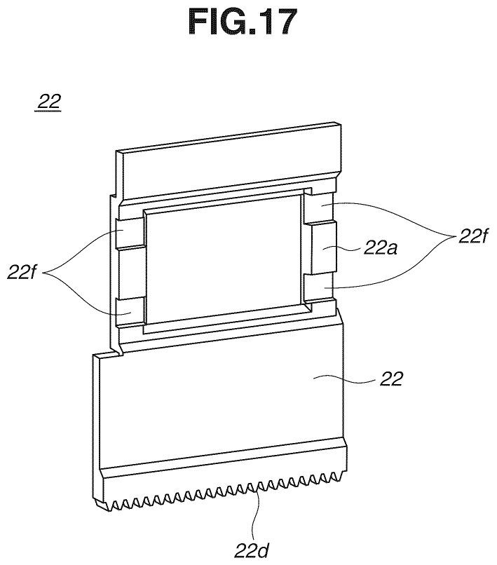

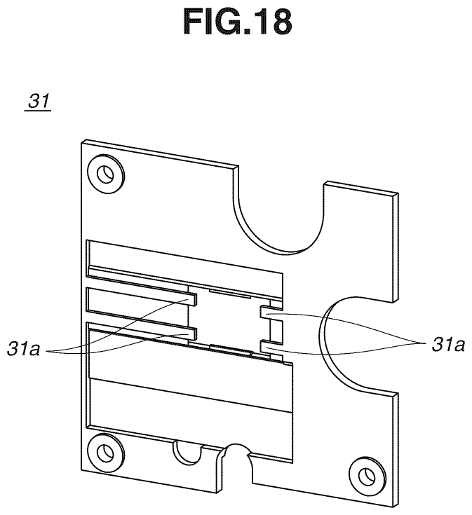

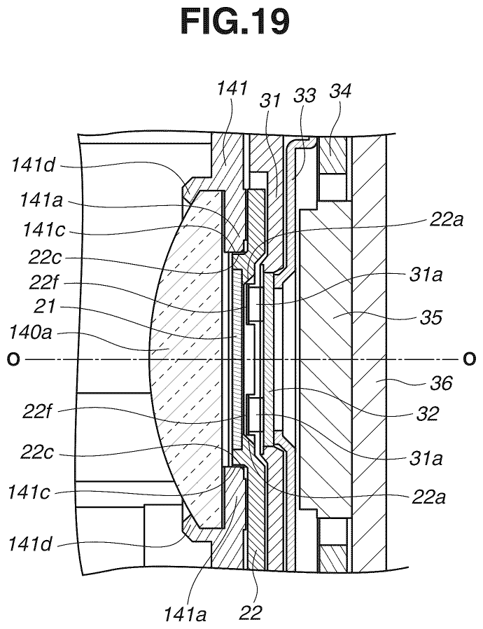

An imaging apparatus according to a fifth exemplary embodiment of the present disclosure will be described below with reference to FIGS. 17 to 19. Components that are in common with the first exemplary embodiment are given the same reference signs and numerals as in the first exemplary embodiment. Description of configurations that are in common with the first exemplary embodiment will be omitted. FIG. 17 is a perspective view of a filter frame according to the fifth exemplary embodiment. FIG. 18 is a perspective view of a second filter holder according to the fifth exemplary embodiment. FIG. 19 is a cross-sectional view of a filter unit and its surroundings according to the fifth exemplary embodiment. The configuration of the second filter holder in the fifth exemplary embodiment is different from that in the first exemplary embodiment.

Second filter holding parts 31a are partially formed. A filter holding part 22a of a filter frame 22 has recesses 22f. The recesses 22f are formed at positions that overlap the second filter holding parts 31a as viewed in an optical axis direction.

As viewed in the direction perpendicular to the optical axis, the second filter holding parts 31a are arranged at positions where the filter holding part 22a and the second filter holding parts 31a at least partially overlap in the optical axis direction.

Specifically, the filter frame 22 has recesses in which the second filter holding parts 31a are partially arranged. This allows the filter 21 and the second filter 32 to be closer to each other, thereby making it possible to shorten a backfocus and make the imaging apparatus thinner.

As in the third exemplary embodiment, the filter 21 or the filter holding part 22a and the filter holding part 141d may at least partially overlap in the optical axis direction. In addition, as in the fourth exemplary embodiment, the fourth lens unit 140 may move in the optical axis direction of the imaging optical system.

With the above-described configuration, it is possible to provide an imaging apparatus equipped with a filter insertion/removal mechanism that can shorten a backfocus.

Although some exemplary embodiments of the present disclosure have been described above, the present disclosure is not limited to these exemplary embodiments, and various modifications and changes are possible within the scope of the present disclosure. In addition, there is no limitation on configurations of exemplary embodiments as long as the design function is taken into consideration.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-133859, filed Aug. 21, 2023, which is hereby incorporated by reference herein in its entirety.

What is claimed is:

1. An imaging apparatus comprising:
a lens holder having an opening and configured to hold a lens; and
a filter holder configured to hold a filter such that the filter is insertable to and removable from an optical path of the lens,
wherein at least one of the filter or the filter holder is at least partially arranged in the opening so as to overlap at least a portion of the lens holder as viewed in a direction perpendicular to an optical axis direction of the lens.

2. The imaging apparatus according to claim 1, wherein the filter holder is at least partially arranged in the opening so that the filter and the lens holder at least partially overlap as viewed in the direction perpendicular to the optical axis direction of the lens.

3. The imaging apparatus according to claim 1, wherein a diagonal length of the filter is shorter than a diameter of the lens.

4. The imaging apparatus according to claim 1, wherein the filter moves along a long-side direction of the filter.

5. The imaging apparatus according to claim 1, wherein a side surface of the lens holder engages with a side surface of the filter holder.

6. The imaging apparatus according to claim 1, wherein the lens holder includes a guide pin, and the guide pin engages with a guide hole provided in the filter holder.

7. The imaging apparatus according to claim 1, further comprising:
a second filter; and
a second filter holder configured to hold the second filter,
wherein the filter holder overlaps at least a portion of the second filter holder as viewed in the direction perpendicular to the optical axis direction of the lens.
